(19) United States
(12) Patent Application Publication
(10) Pub. No.: US 2025/0365674 A1
(43) Pub. Date: Nov. 27, 2025

(54) Power-Saving Method and Communication Device Capable of Performing Radio Frequency Doze Mode

(71) Applicant: MEDIATEK INC., Hsinchu City (TW)

(72) Inventors: Tsung-Che Lu, Hsinchu City (TW); Kuan-Po Liu, Hsinchu City (TW)

(73) Assignee: MEDIATEK INC., Hsinchu City (TW)

(21) Appl. No.: 19/206,088

(22) Filed: May 13, 2025

Related U.S. Application Data
(60) Provisional application No. 63/651,019, filed on May 23, 2024.

(51) Int. Cl. H04W 52/02

(52) U.S. Cl. CPC H04W 52/0264

(57) ABSTRACT

A power-saving method for a communication device includes performing data transmission in an active mode, after the data transmission is completed, entering a radio frequency (RF) doze mode to periodically alternate between a receive (RX) on state and an RX off state, during the RX on state in the RF doze mode, performing a Clear Channel Assessment (CCA) detection on an operating channel of the communication device, to determine whether the operating channel is idle or busy, and if the operating channel is detected as busy during the RX on state in the RF doze mode, switching from the RF doze mode to the active mode.

### CROSS REFERENCE TO RELATED APPLICATIONS

This application claims the benefit of U.S. Provisional Application No. 63/651,019, filed on May 23, 2024. The content of the application is incorporated herein by reference.

### BACKGROUND

Power saving is a significant issue for battery-operated devices, such as mobile phones. The industry consistently focuses on reducing power consumption to extend battery life and enhance product competitiveness. In a typical Wi-Fi station scenario, a significant amount of power is consumed in a receive listen state (RX listen state). This occurs even when the station is not actively transmitting or receiving data, leading to unnecessary power usage.

For example, in current solutions, a station can wait for 200 milliseconds in the listening period. The listening period is referred to as the Keep-Alive Time (KAT). The purpose of the KAT is to confirm that the access point has no more packets to send, allowing the station to enter the power-saving mode. The problem with the current solution is that during the KAT period, the station remains in the RX listen state without actively transmitting or receiving packets, which leads to additional power consumption.

### SUMMARY

In an embodiment, a power-saving method for a communication device is disclosed. The power-saving method includes performing data transmission in an active mode, after the data transmission is completed, entering a radio frequency (RF) doze mode to periodically alternate between a receive (RX) on state and an RX off state, during the RX on state in the RF doze mode, performing a Clear Channel Assessment (CCA) detection on an operating channel of the communication device, to determine whether the operating channel is idle or busy, and if the operating channel is detected as busy during the RX on state in the RF doze mode, switching from the RF doze mode to the active mode.

In another embodiment, a communication device includes an RF transceiver module and a controller. The controller is coupled to the RF transceiver module and configured to control the RF transceiver module. The controller controls the RF transceiver to execute the following operations: performing data transmission in an active mode, after the data transmission is completed, entering an RF doze mode to periodically alternate between an RX on state and an RX off state, during the RX on state in the RF doze mode, performing a CCA detection on an operating channel of the communication device, to determine whether the operating channel is idle or busy, and if the operating channel is detected as busy during the RX on state in the RF doze mode, switching from the RF doze mode to the active mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of an active mode and a power-saving mode of a wireless communication device.

FIG. 2 is a schematic diagram of a communication device according to an embodiment of the present invention.

FIG. 3 is a schematic diagram of chip power variations under an active mode and a radio frequency (RF) doze mode of the communication device in FIG. 1.

FIG. 4 is a schematic diagram of receiving a data packet under a first scenario of the communication device in FIG. 1.

FIG. 5 is a schematic diagram of receiving a re-transmitted data packet under a second scenario of the communication device in FIG. 1.

FIG. 6 is a schematic diagram of receiving the re-transmitted data packet under a third scenario of the communication device in FIG. 1.

FIG. 7 is a flowchart of performing a power-saving method by the communication device in FIG. 1.

### DETAILED DESCRIPTION

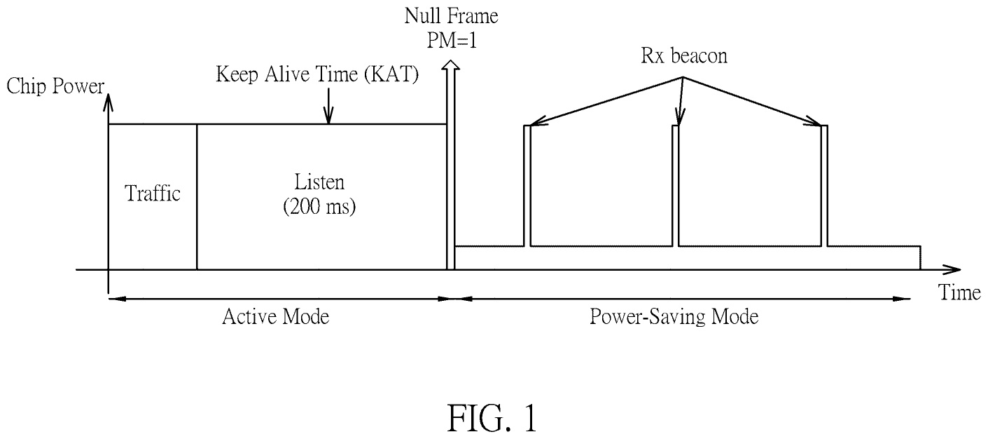

FIG. 1 is a timing diagram of an active mode and a power-saving mode employed by a wireless communication device, such as a Wi-Fi station (STA) currently used. FIG. 1 shows the device's operational modes and relative power consumption over time. The x-axis represents the timeline. The y-axis represents the power consumption level of the device. The operation begins with the device in an active mode. During the active mode, the device may engage in active data exchange, represented by the “Traffic” period, where power consumption is relatively high due to the active mode of transmitter and receiver circuits since they are enabled.

Following the cessation of active data traffic, the device enters a “listen” state before transitioning to a lower power state. The listen state, also referred to as the Keep Alive Time (KAT), is a duration (e.g., 200 milliseconds) during which the device keeps its receiver circuitry fully powered and active to listen for any possible incoming transmissions from an associated access point (AP) or other devices. The purpose of the KAT period is to ensure that the other device has no immediate data to send to the wireless communication device before the station enters the power-saving mode. As illustrated, the power consumption during the Listen state remains high, comparable to the Traffic period, because the receiver needs to be ready to receive potential packets so that the receiver circuits are still enabled.

At the end of the KAT period, if no traffic is detected for the KAT (i.e., during a listening period) and the wireless communication device decides to transition to the power-saving node, it transmits a specific signal to the AP. For example, the wireless communication device sends a “null frame” with the Power Management (PM) bit set to 1. The null frame having PM=1 can inform the AP or other devices that the wireless communication device station is entering the power-saving mode. A brief spike in power consumption occurs during the transmission of this null frame.

Subsequently, the wireless communication device enters the power-saving mode, referred to as a specific mode like DTIM (Delivery Traffic Indication Message) mode. In the power-saving mode, the wireless communication device significantly reduces its power consumption by deactivating major portions of its circuitry, including potentially Microcontroller Unit (MCU), Medium Access Control (MAC) unit, Physical Layer (PHY) circuit, and Radio frequency (RF) circuit. However, it periodically wakes up at predetermined intervals to listen for Beacon frames transmitted by the AP or other devices, indicated as “Rx beacon” events. The beacon frames inform the communication device about the network status and whether the AP has buffered data waiting for it. This cycle of low-power sleep and periodic beacon reception continues as long as the communication device in the power-saving mode and has no data to transmit/receive.

In other words, the communication device switches to the active mode for exchanging data with the AP. After completing the data transmission, the communication device does not immediately enter the power-saving mode. Instead, it enters a waiting/listening period to ensure that the AP has no more packets to send to the communication device. During the waiting period (KAT), the communication device remains in the RX listen state, which allows it to actively listen for any incoming packets from the AP. If no further packets are received within this period, the communication device then transitions into the power-saving mode to conserve energy.

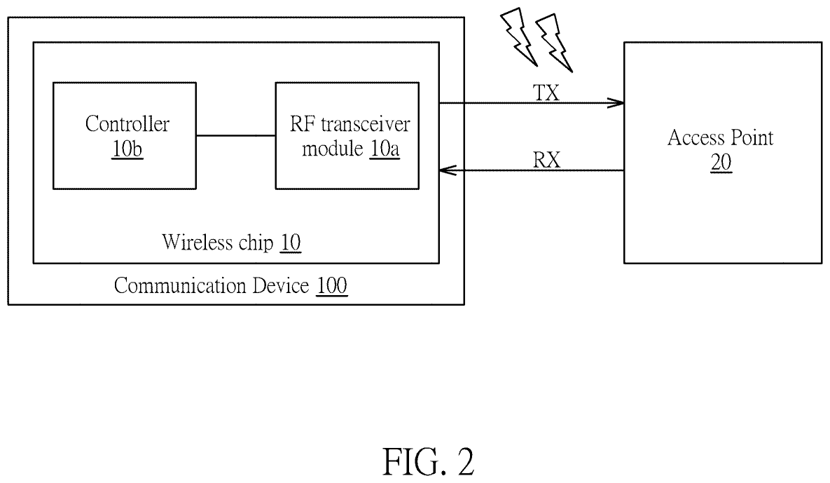

FIG. 2 is a schematic diagram of a communication device 100 according to an embodiment of the present disclosure. The communication device 100 is designed to address the power consumption issue in Wi-Fi stations, especially during the receive listen state (RX listen state). In typical Wi-Fi operations, a station consumes a significant amount of power while waiting to receive possible data from an access point, even when no data is being transmitted or received. This is because the station needs to keep its receiving functions active (i.e., receiving circuit enabled/powered on) to listen for potential transmissions. The waiting period is referred to as a Keep-Alive Time (KAT). To further mitigate power consumption, the communication device 100 employs a mechanism/feature called a radio frequency (RF) doze mode. The communication device 100 can dynamically adjust the activity of its wireless chip during the RF doze mode by alternating between an RX on state and an RX off state. In other words, the communication device 100 periodically enters the RX on state to be able to detect and receive packets/signals, and if necessary, the communication device 100 exits the RF doze mode and enters the active mode to resume normal operation. The RF doze mode effectively balances power efficiency and performance by dynamically managing the RX state of the receiving (RX) circuit of the communication device 100. By doing so, the communication device 100 can reduce power consumption during the KAT period (for example, a predetermined time period for the transition from the active mode to the power-saving mode, such as 200 milliseconds) without sacrificing its ability to receive data.

In FIG. 2, the communication device 100 may include an RF transceiver module 10a and a controller 10b. The communication device 100 can be an AP or a station. In some embodiments, the communication device 100 is a battery-operated device capable of managing Wi-Fi power consumption by implementing a mechanism to control the RF doze mode of its antennas and RX circuitry. For simplicity of illustration, the communication device 100 is depicted as a station in FIG. 1. In the example of FIG. 1, the RF transceiver module 10a and the controller 10b can be integrated into a wireless chip 10, but the present disclosure is not limited thereto. The wireless chip 11 can be a Wi-Fi chip or any chipset capable of enabling wireless communication. The RF transceiver module 10a processes the transmission and reception of wireless signals, ensuring the communication device 100 can effectively send and receive data. The controller 10b can be a Microcontroller Unit (MCU) and configured to execute instructions and perform calculations necessary for the operations of the RF transceiver module 10a. For example, the controller 10b can control the RF transceiver module 10a to perform the RF doze mode for power saving and dynamically enable and disable at least one RX function. For example, the communication device 100 receives and transmits signals through at least one antenna, and the RF transceiver module 10a may comprise at least one RF path coupled to the antenna and at least one baseband (BB) path coupled to the RF path. The RF Path is configured to convert baseband signals into RF signals for transmission and vice versa for reception. For example, the RF path may include components such as frequency synthesizer (SX), filters, amplifiers, and mixers, wherein the frequency synthesizer (SX) is configured to provide frequency signals to the mixers to perform frequency conversion.

The baseband path may include components such as analog-to-digital converters (ADC), digital-to-analog converters (DAC), and digital signal processors (DSP). It can be understood that the RF transceiver module 10a can be described as at least including a PHY circuitry and the frequency synthesizer, wherein the PHY circuitry is responsible for processing all functions of the physical layer, such as including signal transmission and reception, modulation and demodulation, encoding, decoding, etc. In the embodiment, the PHY circuitry can include at least portion of the circuits in the above-mentioned baseband path and/or RF path.

It should be understood that within the communication device 100, while at least one antenna may be physically located externally to the wireless chip 10, the antenna is electrically coupled to the RF transceiver module 10a of the wireless chip 10. Consequently, the power supplied to at least one antenna originates from or is controlled by the RF transceiver module 10a. Therefore, references hereafter to placing at least one antenna into a “standby mode” or a “shutdown mode” should be interpreted as controlling the specific circuitry within the RF transceiver module, which is responsible for providing electrical power to at least one antenna, to enter a corresponding standby or shutdown state. The action effectively powers down or places the antenna interface into a lower power state by managing its power source circuit within the RF transceiver module.

In FIG. 1, since the communication device 100 functions as the station, the communication device 100 communicates with the AP 20. In the embodiment, wireless signals are transmitted from the communication device 100 to the AP 20 and received by the AP 20. In the communication device 100, the controller 10b may control the RF transceiver module 10a to enter an active mode for performing data transmission (for example, transmitting/receiving the wireless signals/packets). Then, after the data transmission is completed, the controller 10b may control the RF transceiver module 10a to enter the RF doze mode by periodically alternating between the RX on state and the RX off state. For example, when a predetermined condition for entering the RF doze mode is met, the RF transceiver module 10a enters the RF doze mode. Further, the controller 10b may control the RF transceiver module 10a to exit the RF doze mode and re-enter the active mode. In the embodiment, the RX on state enables the RF transceiver module 10a to receive the wireless signals (i.e., the RX functions of the RF transceiver module 10a are enabled). In other words, during the communication device 100 being in the RX on state of the RF doze mode or in the active mode, RX circuitry (for example, within the RF transceiver module 10a) of the communication device 100 is enabled. The RX off state disables the RF transceiver module 10a from receiving the wireless signals (i.e., the RX functions of the RF transceiver module 10a are disabled). In other words, during the communication device 100 being in the RX off state of the RF doze mode, at least portion of RX circuitry (for example, within the RF transceiver module 10a) of the communication device 100 is in a standby state and/or disabled. The RX off state consumes less power than the RX on state.

It should be noted that the RF doze mode is different from the power-saving mode. The power-saving mode is a more energy-efficient state compared to the RF doze mode. In the power-saving mode, the communication device 100 powers down the related circuits including the MCU, MAC unit, PHY circuitry, and RF circuitry, effectively turning them off to conserve energy. In contrast, in the RF doze mode as described in this embodiment, when the communication device 100 is in the RX off state in the RF doze mode, certain RX circuitry, such as the PHY circuitry, remain in a standby state rather than being completely powered down. The RF doze mode provides a quicker transition back to full operation (the RX on state) while still achieving a degree of power conservation. Details of performing a power-saving method by the communication device 100 are illustrated below.

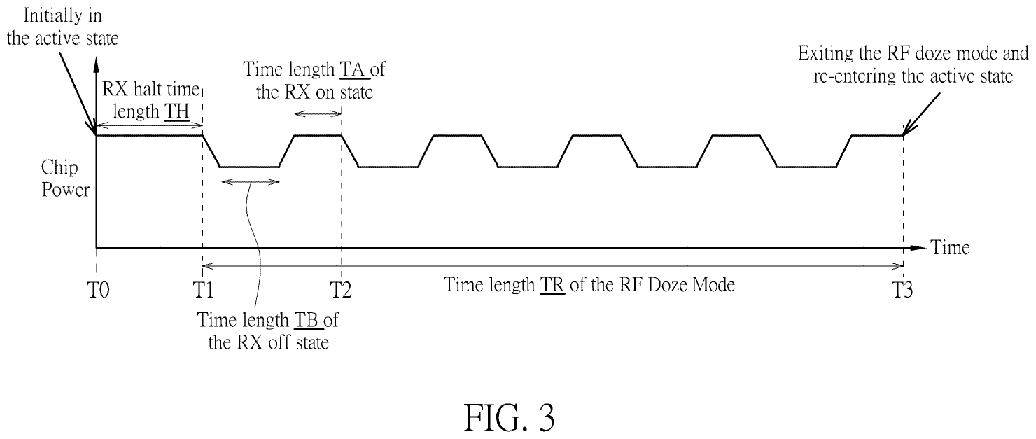

FIG. 3 is a schematic diagram of chip power variations under the active mode and the RF doze mode of the communication device 100. In FIG. 3, Y-axis represents a level of chip power. X-axis represents a timeline. At the beginning, the processor 10 activates all functions of the RX circuitry within the wireless chip 11, enabling the wireless chip 11 to achieve full data-receiving capability under the active mode. In FIG. 3, a time point TO represents the beginning of a monitoring phase within the active mode, when active data transmission or reception is completed. At time point TO, the communication device 100 is fully equipped to receive any incoming data. After the time point TO, within the RX halt time length TH (a predetermined period), the controller 10b may determine whether a predetermined condition for entering the RF doze mode is met. If the predetermined condition is met, the RF transceiver module 10a enters the RF doze mode. The RX halt time length TH is set before entering the RF doze mode to continuously determine the predetermined condition for entering the RF doze mode during the RX halt time length. The predetermined conditions may include but are not limited to: no transmission being performed by the communication device 100 within the RX halt time length TH, no reception being performed by the communication device 100 within the RX halt time length TH, and the operating channel being detected as idle within the RX halt time length TH.

Specifically, a CCA (Clear Channel Assessment) detection is performed during the RX on state of the RF doze mode. Through the CCA detection, it is possible to determine whether the channel is clear or busy. For example, the CCA process involves the communication device sensing the energy level on its designated operating channel. The detected CCA energy level is then compared against a predefined threshold. If the sensed CCA energy level is below the predefined threshold, the communication device 100 determines that the operating channel is currently unoccupied or “idle”. Conversely, if the sensed CCA energy meets or exceeds the predefined threshold, it indicates the presence of ongoing transmissions or significant interference, leading the communication device 100 to determine that the operating channel is “busy”. Thus, by performing the CCA detection on its operating channel, the communication device 100 ascertains whether the channel is idle or busy at that moment.

In another embodiment, the predetermined condition may further include an end time of the predetermined period (i.e., the RX halt time length TH) being beyond a predetermined threshold from the nearest Target Beacon Transmission Time (TBTT). One of the conditions evaluated by the communication device 100 before entering the RF doze mode is whether it is currently “Not in TBTT”. It involves determining the proximity of the upcoming, regularly scheduled beacon frame transmission from the AP. Specifically, the communication device 100 assesses if the time interval remaining until the next known TBTT is sufficiently long. If the next TBTT is imminent, meaning the AP's beacon frame is expected shortly, the communication device 100 will refrain from entering the RF doze mode to ensure it remains fully active to receive the essential periodic beacon frame transmission. Conversely, the communication device 100 will only contemplate entering the RF doze mode if it determines that a sufficient time interval exists before the next scheduled TBTT.

In other embodiments, additional factors such as a Received Signal Strength Indication (RSSI) and an RX throughput are also considered. For example, the communication device 100 may detect the RSSI and the RX throughput of the communication device 100 before the time point TO (i.e., during the data transmission). If the RSSI is greater than an RSSI threshold (e.g., −60 dbm) and the RX throughput is less than an RX throughput threshold (e.g., 100 Mbps), the controller 10b can trigger the RF transceiver module 10a to enter the RF doze mode. In other words, when the RSSI is less than the RSSI threshold, the controller 10b can prevent the RF transceiver module 10a from entering the RF doze mode to prioritize reliable signal reception. This is because, in weak signal conditions, the communication device 100 can avoid the potential for increased packet loss and instability in data reception by preventing the wireless chip 11 from entering RF doze mode. When the RX throughput is greater than an RX throughput threshold, the controller 10b can prevent the RF transceiver module 10a from entering the RF doze mode to maintain data transmission efficiency. This is because when the RX throughput is greater than the RX throughput threshold, it signifies that the communication device 100 can be experiencing a high volume of data traffic. Therefore, to prevent performance degradation and ensure smooth data flow, the controller 10b can prevent the RF transceiver module 10a from entering the RF doze mode when the RX throughput is high. As a result, the RF transceiver module 10a can remain fully active (on) to process the incoming data stream without creating bottlenecks. Further, the RX Halt time length TH is adjustable, with its value affecting how quickly or slowly the wireless chip 11 can enter the RF Doze Mode for power-saving. In one example, the preset duration TA for the RX off state in the RF doze mode is greater than or equal to the preset duration TB for the RX off state in the RF doze mode. More specifically, the RX Halt time length TH is greater than the preset duration TB for the RX off state in the RF doze mode, but the present disclosure is not limited to this.

After the conditions for entering the RF doze mode are met within the RX Halt time length TH, the controller 10b can control the RF transceiver module 10a to enter the RF doze mode at time point T1. In FIG. 3, the RF doze mode can be performed by periodically alternating between an RX on state and an RX off state within a time length TR. When the RF transceiver module 10a enters the RX on state, the controller 10b can enable all functions of the RF transceiver module 10a to achieve full data-receiving capability. Therefore, the communication device 100 can detect and receive packets effectively. The time length of the RX on state is denoted as TA. Further, under the RX on state, the controller 10b can also determine whether to exit the RF doze mode. When the RF transceiver module 10a enters the RX off state, the controller 10b can disable a portion of functions of the RX circuitry of the RF transceiver module 10a to reduce power consumption. Since a portion of the functions of the RF transceiver module 10a are disabled (e.g., turned off or in a standby state), the RX off state consumes less power than the RX on state. The time length of the RX off state is denoted as TB. A time length between the time point T1 and the time point T2 can be referred to as an alternating period of the RF doze mode. Further, when the operating channel is detected as busy under the RX on state, it implies that at least one data packet may be transmitted to the communication device 100. Therefore, the controller 10b can control the RF transceiver module 10a to exit the RF doze mode and re-enter the active mode, such as at time point T3. By doing so, the communication device 100 can reliably receive the incoming data packet.

It should be understood that in conventional communication devices, the duration of the “Listen State” or Keep-Alive Time (KAT), during which the device remains fully active to receive possible incoming packets after data transmission, is often a predetermined fixed period, such as 200 milliseconds. However, in an embodiment of the communication device 100, the conventional listen state is replaced by the RF doze mode. A key difference is the dynamic adaptability of the RF doze mode. Specifically, during the periodic RX on states within the RF doze mode, the communication device 100 monitors the operating channel. If the operating channel is detected as busy (e.g., through the CCA detection), the communication device 100 can immediately exit the RF doze mode and transition back to the normal RX state or active mode to handle the channel activity (such as, receiving possible incoming packets). Consequently, the overall time length TR of the RF doze mode before either receiving data or entering a deeper sleep state is “not fixed” but is dynamically adjusted based on the real-time status of the operating channel. By doing so, the communication device 100 achieves substantial power savings during the RF doze mode while maintaining high throughput efficiency by quickly returning to an active mode when communication is required.

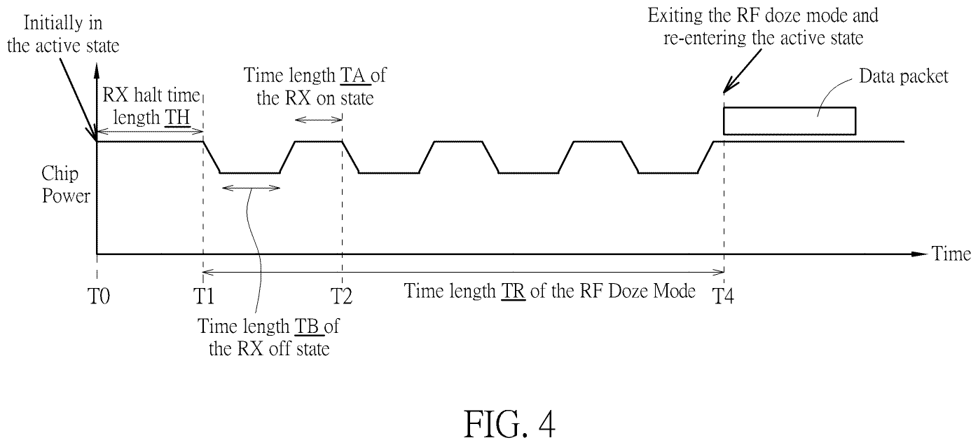

FIG. 4 is a schematic diagram of receiving a data packet under a first scenario of the communication device 100. As previously mentioned, the communication device 100 can be regarded as the station. The AP 20 can transmit the data packet to the communication device 100 at any time. It should be understood that in the operation of the communication device 100 under the RF doze mode, the communication device 100 periodically alternates between the RX on state and the RX off state. Specifically, the CCA detection can be performed during each RX on state. The purpose of performing the CCA detection during each RX on state is to prevent the communication device 100 from missing the reception of incoming data packets. Due to the power-saving properties of the RF doze mode, the RX functions of the RF transceiver module 10a can be active only intermittently. Consequently, there is a risk that data packets arriving during an RX off state cannot be detected. To minimize the undetected risk, the communication device 100 can perform the CCA detection during each RX on state to detect the presence of any wireless signals. If the operating channel is occupied (or say, the operating channel is busy), it implies that a data transmission is in progress or is imminent. Therefore, the communication device 100 can be configured to exit the RF doze mode and revert to the active mode (normal RX on state). Such an RX state converting mechanism ensures that the communication device 100 can be in a fully receptive state to receive the entirety of the incoming data packet. In FIG. 4, the operating channel is detected as busy at time point T4. The controller 11b triggers (or controls) the RF transceiver module 10a to switch from the RF doze mode to the active mode to receive the data packet at time point T4. In the embodiment, the time point T4 is the beginning of transmitting the data packet from the AP 20 to the communication device 100. Therefore, the RF transceiver module 10a of the communication device 100 can successfully receive the “entire” data packet under the active mode. Further, after the RF transceiver module 10a successfully receives the data packet, an acknowledgment signal (ack) can be transmitted from the communication device 100 to the AP 20.

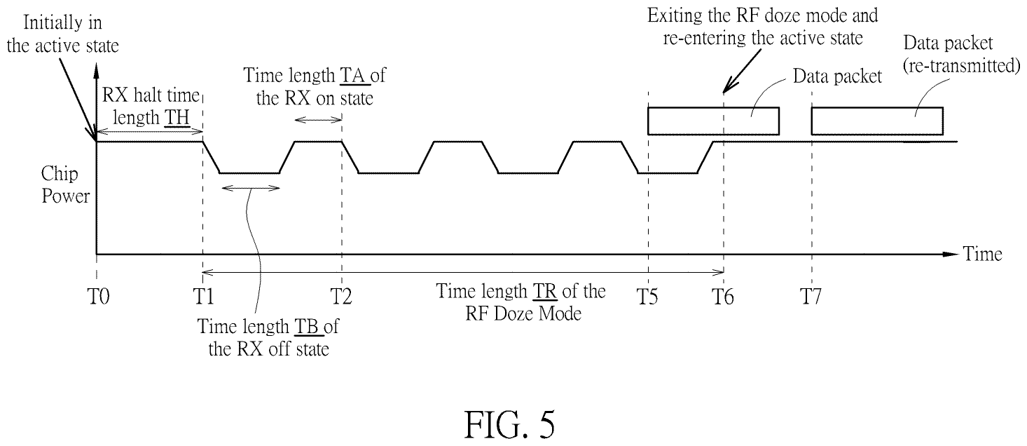

FIG. 5 is a schematic diagram of receiving a re-transmitted data packet under a second scenario of the communication device 100. As previously mentioned, the CCA detection can be performed during each RX on state of the RF doze mode. Therefore, in this embodiment, the AP 20 may transmit a data packet to the communication device 100 at time point T5. However, at time point T5, the RF transceiver module 10a of the communication device 100 is in the RX off state. The RF transceiver module 10a cannot detect the data packet at time point T5. This can cause the communication device 100 to be unable to switch “immediately” from the RF doze mode to the active mode to receive the data packet at time point T5. As time progresses, the RF transceiver module 10a enters the RX on state at time point T6. Once the RF transceiver module 10a enters the RX on state, the communication device 100 (specifically, the wireless chip 11) can perform the CCA detection. Therefore, at time point T6, the communication device 100 can detect whether the operating channel is busy or idle. When the operating channel is detected as busy, the controller 10b then triggers or controls the RF transceiver module 10a to switch from the RF doze mode to the active mode to receive the data packet.

It should be understood that although the controller 10b triggers or controls the RF transceiver module 10a to switch from the RF doze mode to the active mode for receiving the data packet at time point T6, the data packet received by the RF transceiver module 10a beginning at time point T6 is incomplete. The reason for this is that a portion of the data packet (e.g., the portion of the data packet transmitted from the time point T5 to the time point T6) is not received (or say, missed) by the RF transceiver module 10a. Therefore, even if the RF transceiver module 10a starts to receive the data packet at time point T6, the reception of the data packet will fail (due to incompleteness). When the RF transceiver module 10a fails to receive the data packet entirely, the acknowledgment signal will not be generated. Since the acknowledgment signal is not received by the AP 20, the AP 20 may re-transmit the data packet to the communication device 100. Since the wireless chip 11 is now in the active mode, the data packet re-transmitted at time point T7 can be completely received by the wireless chip 11. In other words, in the communication device 100, even if the data packet cannot be received in a certain RX off state, the RF transceiver module 10a can inevitably switch the RF doze mode to active mode in the next alternating period. Therefore, the data packet only needs one retransmission to ensure being received by the RF transceiver module 10a. As a result, the communication device 100 does not cause excessive reception delay while saving power.

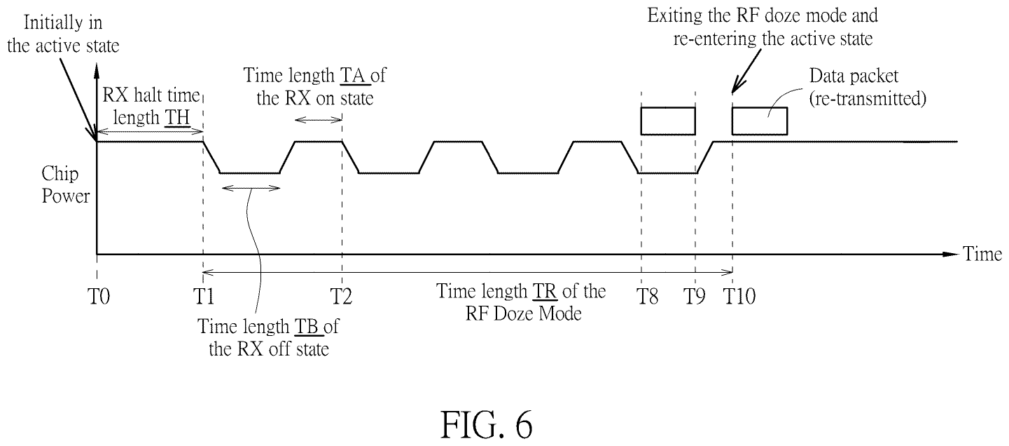

FIG. 6 is a schematic diagram of receiving the re-transmitted data packet under a third scenario of the communication device 100. As previously mentioned in FIG. 5, when only a “portion” of the data packet is within during the RX on state in the RF doze mode, the RF transceiver module 10a can detect the channel is busy based on the CCA detection. Consequently, the RF transceiver module 10a can completely receive the data packet under the active mode upon re-transmission of the data packet. In FIG. 6, the transmission of the data packet from AP 20 to communication device 100 occurs within the duration of the RX off state. As a result, the communication device 100 is unable to detect any portion of the data packet. For instance, the data packet is transmitted to the communication device 100 during the period from a time point T8 to a time point T9. Because the RF transceiver module 10a of the communication device 100 is in the RX off state between time points T8 and T9, it cannot perform reception nor CCA detection.

Subsequently, the RF transceiver module 10a enters the RX on state at time point T10. Upon entering the RX on state, the RF transceiver module 10a gains the capability of CCA detection. When the operating channel is detected as busy, the controller 10b triggers or controls the RF transceiver module 10a to switch from the RF doze mode to the active mode to receive the data packet. It should be understood that, since the RF transceiver module 10a is unable to detect the data packet between time points T8 and T9, the acknowledgment signal will not be generated. Since the acknowledgment signal is not received by the AP 20, the AP 20 may re-transmit the data packet. If the time point at which the data packet is transmitted from the AP 20 to the communication device 100 is after the time point (time point T10) at which the RF transceiver module 10a enters the RX on state in the RF doze mode, the wireless chip 11 can receive the complete data packet and enter the active mode. Conversely, if the time point at which the data packet is transmitted from the AP 20 to the communication device 100 is before the time point (time point T10) at which the RF transceiver module 10a enters the RX on state, then the communication device 100 will encounter the scenario depicted in FIG. 5. In FIG. 6, the communication device 100 can completely receive the data packet after the data packet is re-transmitted for the second time. In FIG. 6, even if the RF transceiver module 10a fails to receive the data packet due to the RX off state, the RF transceiver module 10a can attempt to receive the complete data packet in the next alternating period, thereby minimizing reception delay while conserving power.

In one embodiment, the power-saving mechanism implemented in the communication device 100 relies on the precise management of receiver state timings, specifically through the control of the RX halt time length TH, the RX off state time length TB, and the RX on state time length TA, and their relative parameters. The RX halt time length TH is measured in discrete units, where each unit may represent 32 microseconds (μs). For example, the RX halt time length TH ranges from 0 to 1023 units, equal to an actual time span of 0 μs to 32736 μs (approximately 32.7milliseconds). The adjustable range enables the communication device 100 to adapt to varying network demands and power-saving strategies. The RX on state time length TA may be measured in units of 2 microseconds (μs), offering a higher resolution for timing accuracy. The RX on state time length TA may range from 0 to 63 units, equivalent to an actual time range of 0 μs to 126 μs. Similar to the RX on state time length TA, the RX off state time length TB may be measured in 2-microsecond (us) units. The RX off state time length TB may range from 0 to 255 units, corresponding to a time range of 0 μs to 510 μs. A longer RX off state time length leads to greater power savings. In an embodiment, some default settings of the RX halt time length, the RX off state time length, and the RX on state time length are introduced to provide a balanced strategy between the power-saving level and the communication performance. For example, the RX halt time length is set to 1024 μs. The RX on state time length is set to 60 μs. The RX off state time length is set to 60 μs. All parameters and settings can be dynamically or statically adjusted to optimize communication performance and power consumption based on specific application needs and environmental conditions.

In one embodiment, a power-saving level of the RF doze mode can be set. The power-saving level is one of a first power-saving level and a second power-saving level. In other words, the RF doze mode can be set to a “standby” power-saving mode or a “shutdown” power-saving mode. For example, when the standby power-saving mode is set, the first power-saving level can be applied to the RF doze mode, and at least a portion of RX circuitry in the communication device is in a standby mode under the RX off state. Specifically, in the standby power-saving mode, during the RX off state, the Physical Layer (PHY) circuitry, which handles the transmission and reception of signals (such as over the air interface), is placed into a “standby” state. In the standby state, the PHY circuitry consumes significantly less power than when fully active, but retains essential configuration and can be quickly brought back to full operational status when the device needs to transition back to the RX on state. Simultaneously, a frequency synthesizer (SX) (for example, within the RF transceiver module 10a) for generating the precise carrier frequencies required for wireless communication remains operational (turned on). By keeping the SX active during the standby power-saving mode, the communication device 100 ensures that the necessary local oscillator signals are readily available. This setting can avoid longer delays associated with restarting and stabilizing the SX, thereby facilitating a faster transition from the RX off state back to the RX on state. Furthermore, the antenna interfaces or paths are placed into the “standby” state, that is, at least one antenna is in the standby mode. Similar to the PHY standby state, the antenna interfaces in standby mode consume less power than when actively transmitting or receiving. While in standby, the antennas are not fully shut down, and since the SX remains on, the RF signal paths connected to these antennas can be considered available or quickly made available upon transitioning back to the RX on state.

When the shutdown power-saving mode is set, the second power-saving level can be applied to the RF doze mode, and at least portion of the RX circuitry in the communication device is in a shutdown state under the RX off state. Specifically, in the shutdown power-saving mode, during the RX off state, similar to the standby power-saving mode, the PHY circuitry is placed into the “standby” state. In this state, the PHY circuitry consumes reduced power compared to its fully active mode while retaining certain configurations to allow for eventual reactivation. However, in the shutdown power-saving mode, the SX (for example, within the RF transceiver module 10a) is completely turned off. Deactivating the SX halts the generation of carrier frequencies, leading to significant power savings compared to the standby power-saving mode where the SX remains on.

A consequence of turning the SX off is that the RF signal paths relying on its generated frequencies are effectively disabled. As a result, restarting and stabilizing the SX upon transitioning back to the RX on state requires a certain amount of time, which results in longer wake-up latency compared to the standby power-saving mode. Additionally, contributing to the deeper power savings of the shutdown power-saving mode, the antenna interfaces or paths are placed into a “shutdown” state. The shutdown state represents a more profound power-saving condition for the antenna components compared to the “standby” state utilized in the standby power-saving mode. In the shutdown state, the antennas consume minimal power but require a longer initialization or activation time when transitioning back to the active mode (or the RX on state).

Therefore, the shutdown power-saving mode provides a configuration for the RX off state that prioritizes maximum power reduction by deactivating the frequency synthesizer (SX off) and placing the antennas into the shutdown state, while the PHY circuitry enters standby state. The shutdown power-saving mode achieves lower power consumption than the standby power-saving mode during the RX off intervals but necessitates a longer transition time to return to the fully operational RX on state.

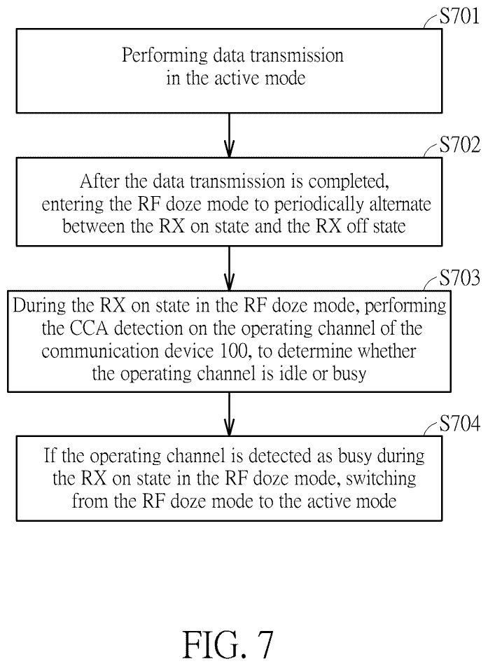

FIG. 7 is a flowchart of performing a power-saving method by the communication device 100. The power-saving method includes steps S701 to S704. Any technology or hardware modification falls into the scope of the embodiments. Steps S701 to S704 are illustrated below.

Step S701: performing data transmission in the active mode;

Step S702: after the data transmission is completed, entering the RF doze mode to periodically alternate between the RX on state and the RX off state;

Step S703: during the RX on state in the RF doze mode, performing the CCA detection on the operating channel of the communication device 100, to determine whether the operating channel is idle or busy.

Step S704: if the operating channel is detected as busy during the RX on state in the RF doze mode, switching from the RF doze mode to the active mode.

Details of steps S701 to S704 are previously illustrated. Thus, they are omitted here. The communication device 100 capable of providing the RF doze mode provides significant advantages over conventional wireless communication devices. Conventional wireless communication devices often suffer from excessive power consumption during the receive listen state, as the RX circuitry remains fully active even when no data packets are being exchanged. While reducing the duration of this listen state can save some power, it introduces the drawback of potentially significant latency if data arrives shortly after the device enters a deeper sleep state. However, the communication device 100 addresses these shortcomings by employing the RF doze mode during the receive listen state. By periodically alternating between the RX on state and the

RX off state within the listen period, the communication device 100 achieves the advantage of substantially reduced power consumption compared to maintaining a continuously active receiver. Further, the power-saving method of the embodiments is attained while mitigating the performance degradation associated with simply shortening the listening time. The periodic RX on state ensures the communication device 100 retains the capability to frequently monitor the channel and detect incoming transmissions or channel activity (e.g., via CCA detection). The power-saving method further ensures that even packets arriving during the RX off state can be reliably received with minimal added delay, typically upon the first retransmission of the data packet attempt by the AP. Consequently, the communication device 100 offers the benefit of an effective balance between enhanced power-saving efficiency and maintained communication performance (i.e., low latency packet reception).

In summary, the embodiments disclose a power-saving method of a communication device. A core concept of the power-saving method centers on mitigating excessive power consumption during the receive listen state. The power-saving method involves performing the RF doze mode by periodically alternating between the RX on state and the RX off state. The periodic alternation provides a significant advantage over conventional approaches by substantially lowering power drain during idle (low-power) listening periods compared to maintaining a continuously active receiver, while concurrently preserving low-latency communication performance through frequent channel monitoring during the RX on states and efficient handling of packet reception, a benefit not realized by simply truncating the listen duration. Therefore, the embodiments offer an improved balance between power efficiency and operational responsiveness, finding wide applicability in various communication devices, such as stations or access points within wireless local area networks (e.g., Wi-Fi systems), and offering particular utility for battery-operated devices requiring extended operational longevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power-saving method for a communication device comprising:
performing data transmission in an active mode;
after the data transmission is completed, entering a radio frequency (RF) doze mode to periodically alternate between a receive (RX) on state and an RX off state;
during the RX on state in the RF doze mode, performing a Clear Channel Assessment (CCA) detection on an operating channel of the communication device, to determine whether the operating channel is idle or busy; and
if the operating channel is detected as busy during the RX on state in the RF doze mode, switching from the RF doze mode to the active mode.

2. The method of claim 1, wherein during the RX off state in the RF doze mode, at least portion of RX circuitry of the communication device is in a standby state and/or disabled.

3. The method of claim 2, wherein during the RX on state in the RF doze mode or in the active mode, the RX circuitry of the communication device is enabled.

4. The method of claim 1, wherein after the data transmission is completed, entering the RF doze mode comprises:
after the data transmission is completed, determining whether a predetermined condition for entering the RF doze mode is met; and
if the predetermined condition is met, entering the RF doze mode.

5. The method of claim 4, further comprising:
setting a RX halt time length by the communication device before entering the RF doze mode for continuously determine the predetermined condition during the RX halt time length.

6. The method of claim 4, wherein the predetermined condition comprises:
no transmission being performed by the communication device within a predetermined period;
no reception being performed by the communication device within the predetermined period; and
the operating channel being detected as idle within the predetermined period.

7. The method of claim 6, wherein the predetermined condition further comprises:
an end time of the predetermined period being beyond a predetermined threshold from the nearest Target Beacon Transmission Time (TBTT).

8. The method of claim 1, further comprising:
setting a power-saving level of the RF doze mode, wherein the power-saving level is set to one of a first power-saving level and a second power-saving level;
wherein when the power-saving level is set to the first power-saving level, at least portion of RX circuitry in the communication device is in a standby mode under the RX off state, and when the power-saving level is set to the second power-saving level, at least portion of the RX circuitry in the communication device is in a shutdown state under the RX off state.

9. The method of claim 8, wherein when the power-saving level is set to the first power-saving level, under the RX off state, a Physical Layer (PHY) circuitry is in the standby mode, a frequency synthesizer (SX) is turned on, and at least one antenna is in the standby mode, and when the power-saving level is set to the second power-saving level, under the RX off state, the PHY circuitry is in the standby mode, the SX is in the shutdown state, and the at least one antenna is in the shutdown state.

10. The method of claim 1, further comprising:
detecting a received signal strength indicator (RSSI) of the communication device;
detecting an RX throughput of the communication device; and
triggering the communication device to enable features with the RF doze mode if the RSSI is greater than an RSSI threshold and the RX throughput is less than an RX throughput threshold.

11. A communication device comprising:
a radio frequency (RF) transceiver module; and
a controller coupled to the RF transceiver module and configured to control the RF transceiver module to execute operations;
wherein the operations comprise:
performing data transmission in an active mode;
after the data transmission is completed, entering an RF doze mode to periodically alternate between a receive (RX) on state and an RX off state;
during the RX on state in the RF doze mode, performing a Clear Channel Assessment (CCA) detection on an operating channel of the communication device, to determine whether the operating channel is idle or busy; and
if the operating channel is detected as busy during the RX on state in the RF doze mode, switching from the RF doze mode to the active mode.

12. The communication device of claim 11, wherein during the RX off state in the RF doze mode, at least portion of RX circuitry of the communication device is in a standby state and/or disabled.

13. The communication device of claim 12, wherein during the RX on state in the RF doze mode or in the active mode, the RX circuitry of the communication device is enabled.

14. The communication device of claim 11, wherein after the data transmission is completed, the controller determines whether a predetermined condition for entering the RF doze mode is met, and if the predetermined condition is met, the communication device enters the RF doze mode.

15. The communication device of claim 14, wherein a RX halt time length is set before entering the RF doze mode to continuously determine the predetermined condition during the RX halt time length.

16. The communication device of claim 14, wherein the predetermined condition comprises:
no transmission being performed by the communication device within a predetermined period;
no reception being performed by the communication device within the predetermined period; and
the operating channel being detected as idle within the predetermined period.

17. The communication device of claim 16, wherein the predetermined condition further comprises:
an end time of the predetermined period being beyond a predetermined threshold from the nearest Target Beacon Transmission Time (TBTT).

18. The communication device of claim 11, wherein a power-saving level of the RF doze mode is set to one of a first power-saving level and a second power-saving level, when the power-saving level is set to the first power-saving level, at least portion of RX circuitry in the communication device is in a standby mode under the RX off state, and when the power-saving level is set to the second power-saving level, at least portion of RX circuitry in the communication device is in a shutdown state under the RX off state.

19. The communication device of claim 18, wherein when the power-saving level is set to the first power-saving level, under the RX off state, a Physical Layer (PHY) circuitry is in the standby mode, a frequency synthesizer (SX) is turned on, and at least one antenna coupled to the RF transceiver module is in the standby mode, and when the power-saving level is set to the second power-saving level, under the RX off state, the PHY circuitry is in the standby mode, the SX is in the shutdown state, and the at least one antenna coupled to the RF transceiver module is in the shutdown state.

20. The communication device of claim 11, wherein a received signal strength indicator (RSSI) and an RX throughput of the communication device are detected, and if the RSSI is greater than an RSSI threshold and the RX throughput is less than an RX throughput threshold, the controller triggers the RF transceiver module to enable features with the RF doze mode.
